(19) United States
(12) Patent Application Publication
(10) Pub. No.: US 2013/0306651 A1
(43) Pub. Date: Nov. 21, 2013

(54) Pressure Vessel for Helium

(71) Applicant: Martin Markert, Nürnberg (DE)

(72) Inventor: Martin Markert, Nürnberg (DE)

(21) Appl. No.: 13/982,506

(22) PCT Filed: Feb. 10, 2012
(86) PCT No.: PCT/EP2012/052356

§ 371 Date: Jul. 30, 2013

(30) Foreign Application Priority Data
Feb. 11, 2011 (DE) 10 2011 000 674.5

(51) Int. Cl. F17C 1/16

(52) U.S. Cl. CPC F17C 1/16
USPC 220/582; 220/581; 220/586

(57) ABSTRACT

The invention relates to a pressure vessel (10) for gases, in particular helium, which is characterized in that the pressure vessel has an outer casing having pressure resistance up to an internal gas pressure of at least 10 bar, in that the outer casing of the pressure vessel has at least one highly diffusion-resistant barrier layer having a leak rate for helium at an internal gas pressure of 10 bar and room temperature of preferably less than 10⁻² mbar·l/s, and in that the vessel has an accommodating volume for gas at atmospheric pressure of at least 25 liters. The outer casing of the pressure vessel can comprise at least one barrier layer made of a flexible polymer film having a high barrier function or ultra barrier function or at least one highly gas-tight flexible barrier layer made of EVOH. The vessel can be bag-like or, in particular at higher pressures, inherently rigid. High-strength plastics made of fiber granular materials, for example, can be used to produce the layer, which guarantees the high pressure resistance. Seams (12) can be provided, for example in the lateral edge areas, in order to reinforce and stabilize the pressure vessel. The pressure vessel (10) according to the invention can have a ball valve (11) as a closing element in order to remove the gas.

### CROSS REFERENCE TO RELATED APPLICATIONS

This application is the U.S. national stage of International Application No. PCT/EP2012/052356, filed on Feb. 10, 2012, and claims the benefit thereof. The international application claims the benefits of German Application No. 102011000674.5 filed on Feb. 11, 2011; all applications are incorporated by reference herein in their entirety.

### BACKGROUND

This invention relates to a pressure vessel for helium or possibly other inert, nontoxic, nonflammable gases. Pressure vessels for helium are used to fill balloons with helium, for instance. Gas cylinders made of steel that have a volume of 1 liters to 50 liters, for example, and a filling pressure of 150 bar to 300 bar, for example, are used on the one hand as customary pressure vessels for helium. These steel containers are relatively heavy and are, moreover, costly to produce and are therefore not purchased by the users as a rule; instead, reusable containers are employed, so the user returns the empty container to the manufacturer to be refilled.

Lightweight metal containers for liquid helium with an accommodating volume in the range of approx. 40 liters to 450 liters have also recently made their presence felt, but they are likewise relatively expensive and therefore do not come under consideration for use as disposable containers. Furthermore, it is to be pointed out with regard to these containers that the helium has to be cooled. If permanent cooling is not ensured, a high internal pressure arises, which makes the handling of the containers by laymen dangerous. These containers are therefore used in technical, scientific or medical fields. Multiple fillings, which introduce impurities, are out of the question because of the gas purity required here.

Pressure vessels for helium are also known that are used as disposable containers and that have a low volume sufficient to fill a few balloons with helium, for instance approximately 20 to 30 balloons, depending on the internal pressure of the container and the size of the balloons. These pressure vessels are made of sheet steel as a rule, and there is the problem, on the one hand, that they will not have a display showing the respective filling pressure in the container. When receiving the pressure container from the manufacturer, the user therefore does not know whether it actually has the specified maximum filling. Complaints consequently come about on a frequent basis, because the volume filled is in dispute. In addition, the user also does not know the level of the remaining filling after using the pressure vessel a number of times, so he cannot estimate how many balloons can still be filled with the pressure vessel. A particular problem with regard to these disposable containers is that they are made of metal and a high fee has to be paid by the dealer or manufacturer for the disposal. These steel containers are therefore questionable in terms of ecology. These disposable containers are also relatively expensive. Moreover, these containers are delivered in a covering box so that they can be set upright for storage; the box has to be disposed of as further outside material because of that. A further drawback of the known disposable containers made of sheet metal is that they are frequently welded, which is a safety risk when the container is under pressure and welding seams have not been created in a professional manner and in accordance with the standards. Corrosion can also come about in the containers because of oxygen components and/or moisture in the filling gas, for example, which likewise reduces the pressure-bearing capability of the containers.

Finally, there are also carbon bottles for helium that have a steel inlay, i.e. that is made of the composite material of a steel/carbon-reinforced plastic. Containers of that type can in fact hold a relatively large amount of gas, because they can be filled with helium with a gas pressure of up to 300 bar. But these containers are expensive and are employed as reusable containers that remain the property of the manufacturer. Containers are likewise involved here, just as in the case of the above-mentioned steel bottles, that require the use of a manometer to display the filling pressure in the container.

Furthermore, flexible, but non-elastic gas bags that are used for the storage of small amounts of gas required for experimental purposes, for instance, are known in the prior art. These gas bags are sold by the company Linde, for example, as “PLASTIGAS®” bags. They hold the gas under atmospheric pressure, however. The gas flows out of the bag with manual pressure. These gas bags are therefore not suitable for filling balloons, because the gas is not under pressure in them. Since the gas in the bag is under atmospheric pressure, the gas amount contained per unit of volume is relatively small. These gas bags are made of plastic-clad aluminum foil and are coated on the inside with polyethylene. Moreover, in the case of bags made of aluminum, printing on the outside that is desired for advertising purposes, for instance, is difficult. Bags of that type cannot be set upright for storage purposes due to the bulbous bag shape on all sides.

Finally, so-called foil balloons are also known, consisting of compound foil that has metallic layers to create a seal. These compound foils have to be very lightweight, because they serve to create the helium balloons themselves and the balloon casing is only permitted to have a weight that still gives the balloon enough lifting pressure and allows it to fly. Containers for higher pressurized gas amounts cannot be produced from this foil material, because the pressure-bearing capability is much too low. A container of that type would burst at an internal pressure of around 2 bar.

When using pressure vessels made of plastic, consideration is to be given to the fact that helium has a high diffusion rate due to the small gas molecules and it consequently very easily diffuses through the vessel wall; it is therefore difficult to create pressure vessels for helium made of plastic that have an adequate gas seal.

This invention starts off here. The task of this invention is to provide a pressure vessel for helium designed in such a way that it holds a sufficient volume of helium to fill up balloons, for instance, but can simultaneously be manufactured in a cost-effective way from a material enabling it to be used as a disposable container in a safe way in terms of ecology.

A pressure vessel for helium with the characterizing elements of the main claim provides a solution to this problem.

### DETAILED DESCRIPTION

The pressure vessel as per the invention has an outer casing made of plastic that has a pressure resistance up to an internal gas pressure of at least 10 bar; the outer casing of the pressure vessel has at least a highly diffusion-resistant barrier layer with a low leakage rate for helium of preferably less than 10⁻² mbar·l/s, especially preferably less than 2×10⁻³ mbar·l/s, at an internal gas pressure of 10 bar and at room temperature and the vessel has an accommodating volume for gas under atmospheric pressure of at least 25 liters.

A pressure vessel for helium can consequently hold an approximate volume of 250 liters of helium at a pressure of 10 bar. That is sufficient to fill up a number of balloons with helium with the vessel contents. The plastic outer casing of the vessel withstands an internal pressure of at least approximately 10 bar, on the one hand, and has such a high level of impermeability to helium, on the other hand, that a pressure loss of more than 1 bar does not arise when storing the full vessel at room temperature, primarily over a time period of six months, preferably with no pressure loss of more than 1 bar over a time period of twelve months. In the case of a vessel with an initial internal pressure of 10 bar, that would be a loss of helium via diffusion of around 10% within six months (which is supposed to be the lower limit), for instance; as a preference, the loss should not be more than 1 bar or around 10% with an initial pressure of 10 bar after a time period of around 12 months of storage after the filling. Loss rates of that type are still acceptable to dealers and consumers. The leakage rate is preferably on the order of between approximately 10⁻⁴ and 10⁻² mbar·l/s with a starting pressure in the interior of the vessel of around 10 bar and at room temperature.

In the case of a vessel with a volume of 30 liters, a pressure drop of 1000 mbar (1 bar) in 12 months corresponds to a leakage rate of 0.00096 mbar·l/s, i.e. somewhat less than 10⁻³ mbar·l/s, if a few simplifying assumptions are made for the flow behavior of the gas. The leakage rate is proportional to the difference in pressure between the interior of the vessel and the pressure outside of the vessel (atmospheric pressure as a rule), though. With an internal pressure of 10 bar, the difference in pressure is 9 bar and the leakage rate would therefore be greater than the cited value by a factor of 9.

The assumption is made here that the vessel is preferably filled with helium with a purity level of at least helium 3.7, that is helium with a purity of 99.97%. The next higher purity level on the market is generally helium 4.6, meaning helium with a purity level of 99.996%. Higher purity levels are likewise possible. The purity should be a value that makes the helium suitable for filling balloons.

The pressure vessel for helium as per the invention preferably has an outer casing that is comprised of at least one layer arrangement or a laminate made of highly gastight plastic or synthetic rubber and at least one layer made of plastic that ensures pressure resistance. The weight of a vessel made of plastic as per the invention is, moreover, substantially less than is the case with a vessel made of metal. That makes it easier to handle a vessel of that type. Disposal is also simpler, and production in high quantities is more cost-effective.

The outer casing of the pressure vessel preferably has at least one outer layer or an arrangement of several outer layers that ensures the pressure resistance of the vessel and at least one inner barrier layer or arrangement of barrier layers that ensures the high impermeability to helium; both of the layers or layer arrangements are firmly bound to one another. The barrier layer should, moreover, have the characteristic that it does not expand, or only expands to such an extent that the impermeability is retained, when the internal pressure increases in the vessel. Attention is to be given here to the fact that helium gas, in contrast to most gases, exists in an atomic form and helium atoms are very small because of the location of helium in the periodic table of elements, which is why helium has a high diffusion rate.

The area that ensures impermeability of the vessel can therefore have multiple layers, just as the area with barrier characteristics can have multiple layers. Both of the layer arrangements or layers should be firmly bound together. The bond can be created via additional adhesive layers between the barrier layers and the pressure-resistive layers, for instance, or the two layers are brought together in a firmly bonded way via gluing, welding or melting, for instance.

With a special preference, the barrier layer (or the arrangement of barrier layers) has a leakage rate for helium with customary purity in the market (see above) of 10⁻³ mbar·l/s or less at an internal gas pressure of 10 bar, an external atmospheric pressure of approx. 1 bar and room temperature. It is to be noted that a layer structure is also conceivable, as an example, with a first inner barrier layer or an arrangement of several inner barrier layers connected toward the outside with one or more layers that have a high level of pressure resistance, to which a second layer or an arrangement of several other layers with barrier characteristics are connected towards the outside, with one or more layers ensuring high pressure resistance then following once again towards the outside. A sandwich-type structure with alternating barrier layers and pressure-resistant layers is consequently conceivable.

In a possible design variant of the invention, the outer casing of the pressure vessel as per the invention is comprised of at least one layer made of a flexible polymer film with a high barrier function or ultra barrier function. As a further preference, the outer casing is comprised of a film or a composite film with at least one support layer made of a polymer to which at least one gas-barrier layer is attached that was created via the controlled hydrolysis and condensation of organically modified Si alkoxides and a subsequent thermally or UV-initiated cross-linkage of the polymerizable groups fixed to the inorganic network (so-called ORMOCER® layer, trademark of the Fraunhofer Institute). Ormocers are organically modified polysiloxanes (belonging to the hybrid polymers) that are obtained via a sol-gel process.

Furthermore, the outer casing of the pressure vessel, in accordance with a further design of the invention, preferably has at least one support layer made of an SiOx vapor-coated plastic to which, as an option, at least one organically modified polysiloxane layer (ormocer layer) of the above-mentioned type is further attached. Layers with high-barrier characteristics for which a diffusion rate of less than 0.1 cm3/m2 d bar results can be obtained via a combination of materials of that type for the outer skin of the vessel. Laminates (composite films) can be created for that, for instance, by coating an SiOx vapor-coated support film with a hybrid polymer of the above-mentioned type and then cladding this support film with at least a further SiOx vapor-coated film layer. Permeabilities of less than 0.01 cm3/m2 d bar can be obtained with that.

In accordance with a possible design variant of the invention, the outer casing of the vessel is comprised of at least one highly gastight, flexible barrier layer made of EVOH (ethylene vinyl alcohol copolymer). Environmentally friendly plastic layers with barrier characteristics can be created from EVOH because the material can be recycled.

High strength plastics made of ionomer blends based on polyethylene (HDPE) or polyamide, or fiber-reinforced plastic made of fiber granules (short fiber granules or long fiber granules) that can be extruded, injection molded or blow molded, for instance, can be used for the pressure resistant layer.

Furthermore, in accordance with a further design of the invention, the pressure vessel for helium as per the invention preferably has a support base on the bottom so that it can be set down on a surface for the purpose of storage.

Moreover, a pressure vessel for helium as per the invention can preferably be filled with a gas pressure of more than 10 bar, preferably with a gas pressure of up to 15 bar, if needed with a gas pressure of up to around 18 bar or around 25 bar, i.e. the vessel contains helium gas with a pressure in the above-mentioned range when it is filled to the maximum amount. With a vessel size of 25 liters, i.e. an accommodating volume of 25 liters for gas under atmospheric pressure, capacities for pressurized helium gas in the range of around 250 liters to 625 liters result; with a vessel size of 30 liters of accommodating volume under atmospheric pressure, for example, capacities for pressurized helium gas of between approximately 300 liters and approximately 750 liters result.

Furthermore, in accordance with a further design of the invention, the vessel preferably has a suitable closure unit for repeated instances of gas removal, in particular a two-way ball valve. This closure unit can, moreover, preferably be equipped by the manufacturer with a securing unit that indicates the removal of gas for the first time. A seal can be used, as an example, and when it is broken, it indicates that the vessel has already been opened. That leads to increased assurance for the user that he has received a gas container in the original condition with a full filling. A closure unit of that type can be glued or screwed into the vessel, for instance.

A pressure vessel as per the invention has the further advantage that it can be easily disposed of by the user, because the vessel is made of a homogeneous material (plastic, synthetic rubber). Only a minimal amount of waste arises, because a relatively thin outer casing suffices. The ball valve used as the closure unit can be screwed off or cut off, for instance, and reused.

A possible manufacturing method is to draw or blow (blow molding) a pressure vessel as per the invention without seams. A drawn or blown body of that type could be put into a bag casing, as an example. Alternatively, though, it is also conceivable to manufacture the vessel with seams that also serve to stabilize the vessel. An advantage of the last-named method is that the pressure vessel can be designed in such a way with seams that a lower support base results so that the vessel can be set down for storage (on a shelf or the like).

The features specified in the sub-claims relate to preferred further design forms of the problem solution in accordance with the invention. Further advantages of the invention ensue from the following detailed description.

### BRIEF DESCRIPTION OF THE DRAWINGS

This invention will be explained in more detail below with the aid of examples making reference to the enclosed drawings. The following are shown:

FIG. 1 a shows a view of a pressure vessel as per the invention;

FIG. 1 b shows a view of the pressure vessel in accordance with FIG. 1 a from the bottom;

FIG. 2 shows a greatly enlarged, schematically simplified section through a small portion of the outer casing of a pressure vessel as per the invention.

### DETAILED DESCRIPTION OF THE PREFERRED EMBODIMENT

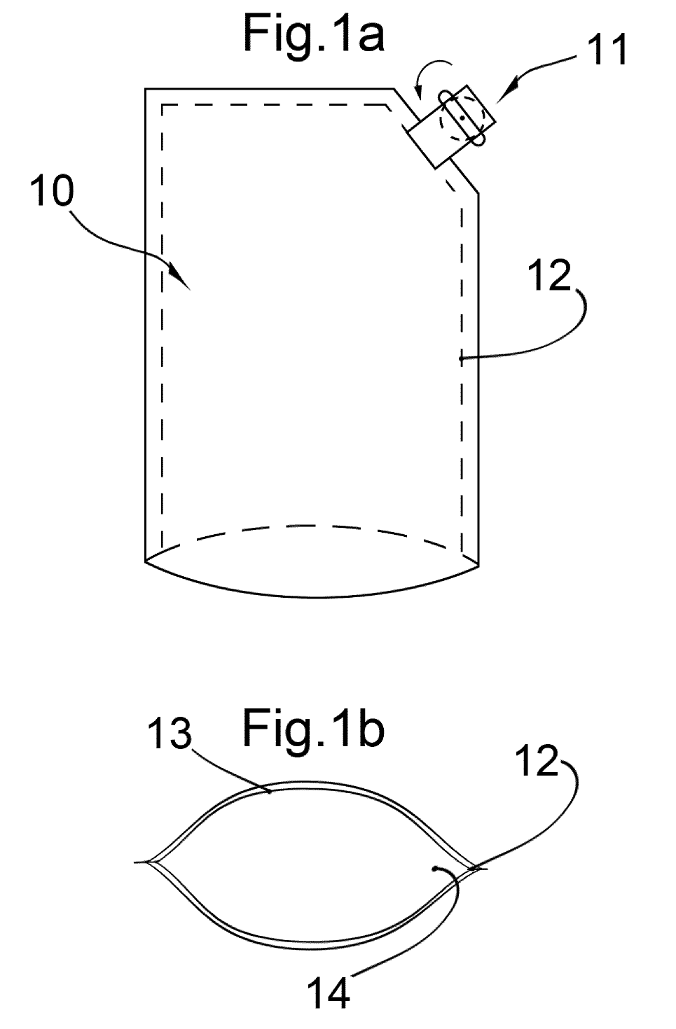

Reference is made, to start with, to FIGS. 1 a and 1 b, and a possible example of a design variant of the vessel as per the invention will be explained in more detail with the aid of the figures. The drawing shows the pressure vessel in a schematically simplified view. This pressure vessel is indicated as a whole with reference numeral 10. This involves, in principle, a type of bag made of plastic or polymer rubber; its interior contains helium with a pressure of 10 bar or 15 bar, for instance, when filled. The size of the pressure vessel can naturally vary over a broad range; as an example, it can be chosen in such a way that the volume of the vessel of around 250 liters to 300 liters up to 750 liters has pressurized helium, so a number of balloons can be filled with the contents of a pressure vessel of that type. If the vessel has a filling volume of 25 liters for gas under atmospheric pressure, for instance, a gas content of around 250 liters results at an internal pressure of 10 bar (assumption of an ideal gas). Gas content of around 250 liters to 300 liters of pressurized helium gas consequently represents the reasonable lower limit for a helium vessel in accordance with the invention.

The pressure vessel as per the invention 10 has a ball valve 11 as a closure unit, which is preferably provided with a seal that is not shown in more detail or is lead-sealed, so that it will immediately be evident when the vessel has already been used and consequently possibly no longer has its full filling as does an unused, original vessel. It is not necessary for the pressure vessel to be provided with a manometer, but a manometer showing the respective filling condition could also be attached in the area of the closure unit as an additional feature.

Since the pressure vessel in this variant of the invention is designed to be a flexible bag, it is only hard and bulbous and cannot be pressed inward by hand when it is completely filled. If the gas is removed, however, and the internal pressure in the vessel diminishes, the vessel becomes softer and capable of being manually pressed inward; the user can recognize that the gas amount is reduced because of that. He can consequently determine when the filling pressure has diminished via pressure with a hand and feeling the vessel as it were. After use, the ball valve 11 can be removed and the empty vessel can be disposed of without problems.

The pressure vessel is made of a flexible, film-type, multi-layer casing and would therefore not retain its shape in and of itself if there were no longer gas pressure in the interior. Seams 12 can therefore be provided in the lateral edge areas that can be seen in FIG. 1 a and FIG. 1 b, for instance, to stiffen and stabilize the pressure vessel. Further seams 13 can exist in the base area, to the effect that the actual base 14 of the vessel 10 sealing the bottom of the filling area is higher than the respective lower ends of the seams 12, 13, and the vessel can therefore be set upright and more or less rests on these seams.

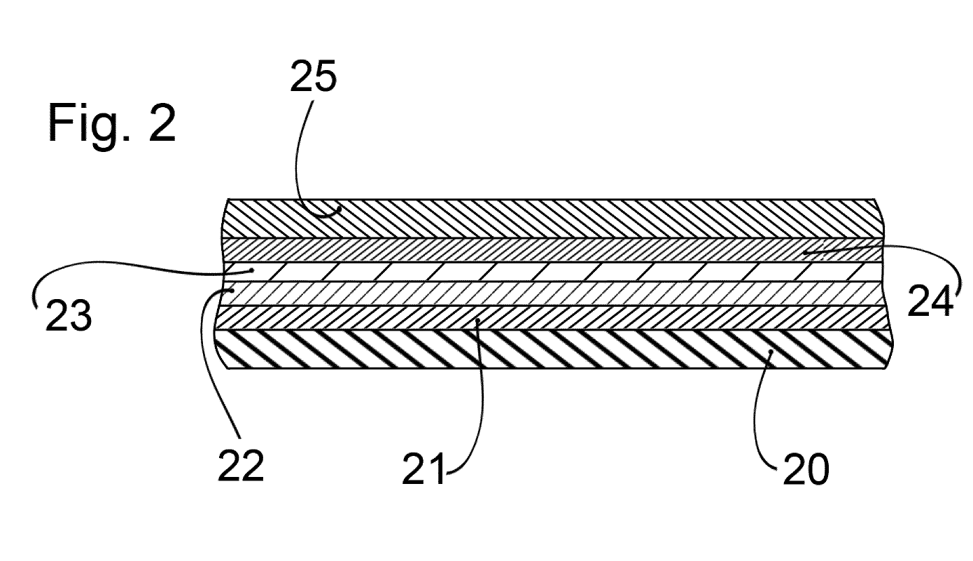

FIG. 2 shows a schematically simplified, greatly enlarged section through the film-type outer casing of a pressure vessel as per the invention. The relative layer thicknesses of the individual layers of the layer structure in the drawing do not have to correspond to the actual layer thicknesses. The layer structure of the outer casing can be recognized there; it is comprised of a first inner layer made of a first film 20 made of plastic that is comprised of polyethylene terephthalate (PET) or a polyolefin such as polyethylene or polypropylene and that is provided, first off, with a SiOx layer 21. A hybrid polymer layer 22 (e.g. ormocer) is applied to that. Now a second film 25 is applied to the first film 20 by means of a laminating adhesive 23. This second film 25 can likewise be made of a PET or one of the other above-mentioned plastics, for instance. This second film 25 is likewise provided with a SiOx layer 24 and, in fact, on the side turned towards the laminating adhesive 23. A laminate made of two film layers that are coated in each case and that form an ultra barrier layer with an extremely tight seal against gas diffusion of helium is obtained in this way.

The previously described variant of the invention relates to vessels for which the gas is under relatively low pressures, for instance on the order of around 10 bar. A further preferred variant of the vessel for higher internal pressures provides for the vessel to be manufactured from a co-extruded, at least two-layer, preferably multi-layer plastic starting material (tube-type preform) via blow molding. Seamless vessels that are not in the nature of bags like the variant describe above, but are instead stiff in and of themselves (after the cooling of the plastic) and are consequently more likely to resemble bottles or cans, result in the process when the vessel has a rectangular base shape, for example or the vessel is roughly cylindrical. But the vessel can have the shape of a ball, an ellipsoid or a different type of solid of revolution, for instance, and its appearance will then resemble that of a pressure-compensating tank as is used in heating systems, for example. The base area of the vessel can also be flattened here so that the vessel has a support base.

### LIST OF REFERENCE NUMERALS

10 Pressure vessel
11 Ball valve
12 Seam
13 Seam
14 Base of the vessel
20 First film
21 SiOx coating
22 Hybrid polymer layer
23 Laminating adhesive
24 SiOx coating
25 Second film

1. Pressure vessel for helium, characterized in that it has an outer casing made of plastic with pressure resistance up to an internal gas pressure of at least 10 bar, that the outer casing of the pressure vessel has at least one highly diffusion-resistant barrier layer with a leakage rate for helium of preferably less than 10⁻² mbar·l/s at an internal gas pressure of 10 bar and room temperature and that the vessel has an accommodating volume for gas under atmospheric pressure of at least 25 liters.

2. Pressure vessel for helium gas according to claim 1, characterized in that the outer casing of the vessel has at least one outer layer or an arrangement of several outer layers that ensures the pressure resistance of the vessel and at least one inner barrier layer or arrangement of barrier layers that ensures the high impermeability to helium, wherein both of the layers or layer arrangements are firmly bound to one another.

3. Pressure vessel for helium gas according to claim 1, characterized in that the barrier layer has a leakage rate for helium of 2×10⁻³ mbar·l/s or less at an internal gas pressure of 10 bar and room temperature.

4. Pressure vessel according to claim 1, characterized in that the outer casing of the pressure vessel is comprised of at least one barrier layer made of a flexible polymer film with a high barrier function or ultra barrier function.

5. Pressure vessel for gases according to claim 1, characterized in that the outer casing of the vessel is comprised of at least one highly gastight, flexible barrier layer made of EVOH.

6. Pressure vessel according to claim 1, characterized in that the outer casing is comprised of a film or a composite film with at least one support layer (20, 25) made of a polymer to which at least one gas barrier layer (22) is applied that was created via the controlled hydrolysis and condensation of organically modified Si alkoxides and a subsequent thermally or UV-initiated cross-linkage of the polymerizable groups fixed to the inorganic network.

7. Pressure vessel according to claim 1, characterized in that the outer casing of the pressure vessel has at least one support layer made of an SiOx vapor-coated plastic.

8. Pressure vessel according to claim 1, characterized in that at least one organically modified polysiloxane layer (22) (ormocer layer) is further applied to at least one support layer made of an SiOx vapor-coated plastic (20, 21).

9. Pressure vessel according to claim 1, characterized in that the pressure vessel has a suitable closure unit for repeated instances of gas removal, especially a two-way ball valve (11).

10. Pressure vessel according to claim 9, characterized in that a closure unit for repeated instances of gas removal, especially a two-way ball valve (11), is connected to the body of the vessel by gluing it in, screwing it in or molding it on.

11. Pressure vessel according to claim 9, characterized in that the vessel is equipped with a securing unit in the area of the closure unit (11) indicating that gas has been removed for the first time.

12. Pressure vessel according to claim 1, characterized in that it is manufactured in a seamless manner via drawing or blow molding.

13. Pressure vessel according to claim 1, characterized in that it has at least one base area forming a support base at the bottom of the vessel.
